(19) United States
(12) Patent Application Publication
(10) Pub. No.: US 2026/0212270 A1
(43) Pub. Date: Jul. 23, 2026

(54) MACHINE LEARNING MODEL FOR PERFORMING IMPUTATION ON A TABULAR DATASET

(71) Applicant: The Toronto-Dominion Bank, Toronto (CA)

(72) Inventors: Brendan Leigh ROSS, Toronto (CA); Jesse Cole CRESSWELL, Toronto (CA); Maksims VOLKOVS, Toronto (CA)

(21) Appl. No.: 19/418,375

(22) Filed: Dec. 12, 2025

Related U.S. Application Data
(60) Provisional application No. 63/748,679, filed on Jan. 23, 2025.

(51) Int. Cl. G06N 20/00; G06N 3/047; G06N 3/0475

(52) U.S. Cl. CPC G06N 20/00; G06N 3/047; G06N 3/0475

(57) ABSTRACT

Methods and systems for generating tabular data. The methods comprise: training, using a diffusion model and a plurality of synthetic tabular datasets representing a prior, a machine learning model to generate a tabular dataset that has a distribution that is consistent with the prior; and using the trained machine learning model to generate all or a portion of a tabular dataset that has a distribution that is consistent with the prior.

### TECHNICAL FIELD

The disclosed example embodiments relate to machine learning models, and systems and methods for using said machine learning models, for performing imputation on a tabular dataset and specifically, machine learning models that are variants of a prior-data fitted network.

### BACKGROUND

Traditionally machine learning models are trained to perform a specific task. Specifically, traditionally machine learning models are trained on a specific labelled dataset to learn and replicate the relationship between the input(s) and the output(s) in the labelled dataset. For example, as shown in FIG. 1, a machine learning model may be trained to predict an output y based on an input x from a training dataset comprising (x, y) pairs. At inference time the trained model receives a new x and generates a prediction for y.

However, since the model is trained on a specific dataset it is difficult to use it to make a prediction based on another dataset that is, for example, in another domain. In other words, a model trained on one dataset may be suboptimal at making a prediction for another dataset with different properties such as a different shape and number of inputs and/or outputs. To obtain a prediction based on the other dataset, it may be necessary to train another model on the other dataset.

Generating and maintaining one model per dataset is both labour and time intensive and requires significant computing resources to store each model.

### SUMMARY

The following summary is intended to introduce the reader to various aspects of the detailed description, but not to define or delimit any invention.

A first aspect provides a system for generating tabular data, the system comprising: a memory, a communication interface, and at least one processor operatively coupled to the memory and the communication interface; the at least one processor configured to: train, using a diffusion model and a plurality of synthetic tabular datasets representing a prior, a machine learning model to generate a tabular dataset that has a distribution that is consistent with the prior; and use the trained machine learning model to generate all or a portion of a tabular dataset that has a distribution that is consistent with the prior.

The at least one processor may be further configured to, prior to using the trained machine learning model to generate all or a portion of the tabular dataset with a distribution that is consistent with the prior, condition the trained machine learning model to generate the tabular dataset in accordance with additional information.

The additional information may comprise (i) an input tabular dataset comprising one or more datapoints, each datapoint comprising one or more elements, and (ii) information identifying one or more elements of the input tabular dataset that are to be generated, and the conditioned trained machine learning model may be configured to generate the identified one or more elements of the input tabular dataset based on the other elements of the input tabular dataset.

Using the trained machine learning model to generate all or a portion of the tabular dataset that has a distribution that is consistent with the prior may comprise using the trained machine learning model to perform one of classification, regression, data generation and data imputation.

The identified one or more elements may comprise each of the one or more elements of one or more datapoints of the input tabular dataset.

The identified one or more elements may comprise only a subset of the one or more elements of a datapoint of the input tabular dataset.

The information identifying the one or more elements of the input tabular dataset that are to be generated may comprise a mask.

The machine learning model may comprise a transformer architecture.

A synthetic tabular dataset of the plurality of synthetic tabular datasets may comprise one or more datapoints, and each datapoint of the one or more datapoints may comprise one or more elements; and the machine learning model may be configured to tokenize each element of the synthetic tabular dataset.

One or more synthetic tabular datasets of the plurality of synthetic tabular datasets may be generated by sampling a Bayesian neural network.

One or more of the synthetic tabular datasets of the plurality of synthetic tabular datasets may be generated by sampling a structural causal model.

The at least one processor may be configured to train the machine learning model using the diffusion model and the plurality of synthetic tabular datasets by diffusing each of the plurality of synthetic tabular datasets in accordance with a diffusion process to generate a plurality of diffused datasets and adjusting parameters of the machine learning model to reverse the diffusion process on the plurality of diffused datasets.

Adjusting the parameters of the machine learning model to reverse the diffusion process may comprise adjusting the parameters of the machine learning model so that the machine learning model generates, in response to receiving a diffused dataset, the corresponding synthetic tabular dataset.

A second aspect provides a method for generating tabular data, the method executed in a computing environment comprising at least one processor, a communication interface, and memory, and the method comprising: training, using a diffusion model and a plurality of synthetic tabular datasets representing a prior, a machine learning model to generate a tabular dataset that has a distribution that is consistent with the prior; and using the trained machine learning model to generate all or a portion of a tabular dataset that conforms to the prior.

The method may further comprise, prior to using the trained machine learning model to generate all or a portion of the tabular dataset with a distribution that is consistent with the prior, conditioning the trained machine learning model to generate the tabular dataset in accordance with additional information.

The additional information may comprise (i) an input tabular dataset comprising one or more datapoints, each datapoint comprising one or more elements, and (ii) information identifying one or more elements of the input tabular dataset that are to be generated, and the conditioned trained machine learning model may be configured to generate the identified one or more elements of the input tabular dataset based on the other elements of the input tabular dataset.

Using the trained machine learning model to generate all or a portion of the tabular dataset that has a distribution that is consistent with the prior may comprise using the trained machine learning model to perform one of classification, regression, data generation and data imputation.

The machine learning model may comprise a transformer architecture.

A synthetic tabular dataset of the plurality of synthetic tabular datasets may comprise one or more datapoints, and each datapoint of the one or more datapoints may comprise one or more elements; and the machine learning model may be configured to tokenize each element of the synthetic tabular dataset.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic diagram illustrating inputs and outputs of a traditional trained machine learning model;

FIG. 2 is a schematic diagram illustrating inputs and outputs of a prior-data fitted network (PFN);

FIG. 3 is a schematic diagram illustrating inputs and outputs of a diffusion PFN;

FIG. 4 is a block diagram of an example system for generating a diffusion PFN and using the diffusion PFN to generate data;

FIG. 5 is a block diagram of an example implementation of the cloud-based computing cluster of FIG. 4 configured to generate a diffusion PFN and use the diffusion PFN to generate data;

FIG. 6A is a schematic diagram of an example Bayesian neural network (BNN);

FIG. 6B is a schematic diagram of an example Structural Causal Model (SCM);

FIG. 6C is a schematic diagram of example SCMs sampled from a prior;

FIG. 7A is a schematic diagram illustrating a first example of using a conditioned diffusion PFN to generate tabular data;

FIG. 7B is a schematic diagram illustrating a second example of using a conditioned diffusion PFN to generate tabular data;

FIG. 8 is a block diagram of an example computer; and

FIG. 9 is a flow diagram of an example method for generating tabular data.

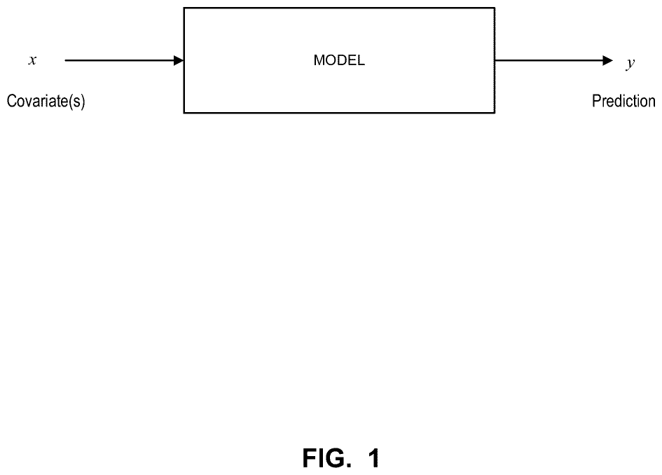

### DETAILED DESCRIPTION

Recently there has been a significant amount of work on building foundation models. Foundation models are machine learning models that are trained on a variety of datasets so they can be applied to multiple use cases. In other words, foundation models can generalize over many different datasets of different shapes and qualities of features. LLMs are examples of foundation models.

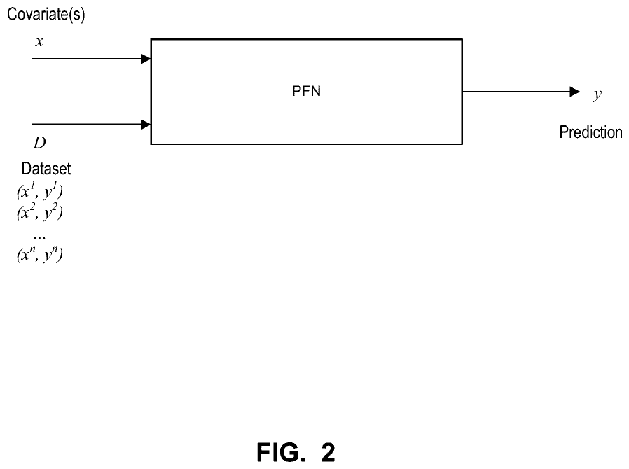

Mueller et al. in “Transformers Can Do Bayesian Inference”, International Conference of Learning Representations, 2021, introduces the concept of a prior-data fitted network (PFN) which is a large machine learning model, such as a Transformer encoder, which is trained offline once, to approximate Bayesian inference on synthetic datasets from a prior. Specifically, as shown in FIG. 2, a PFN is designed to receive an input x, and a test or reference dataset, D, comprising an arbitrary number n of datapoints

$${d}^{( i )} = ( {x}^{( i )} , {y}^{( i )} ) = ( {d}_{1}^{( i )} , … , {d}_{k}^{( i )} ) where {d}_{k}^{( i )} = y and {y}^{( i )}$$

is the output for x⁽ⁱ⁾

$$( i . e . , D = \{ {d}^{( 1 )} , … , {d}^{( n )} \} = {\{ ( {x}^{( i )} , {y}^{( i )} ) \}}_{i = 1}^{n} ) ;$$

and predict an output y based on x and D. More specifically the PFN is configured to generate the posterior predictive distribution (PPD) p(y|x, D)—i.e., the distribution over possible values of y for the input x-in a single forward pass.

A PFN is pre-trained on a plurality of distinct test datasets which are synthetically generated from a prior. This pre-training may be referred to as the prior fitting stage or phase, or the offline phase. Specifically, a plurality of synthetic datasets is generated by sampling a prior. In particular, each synthetic dataset comprises a plurality of datapoints d⁽ⁱ⁾=(x⁽ⁱ⁾, y⁽ⁱ⁾). For each of the plurality of synthetic datasets a test dataset D is generated which comprises a subset of the datapoints d⁽ⁱ⁾=(x⁽ⁱ⁾, y⁽ⁱ⁾) in the synthetic dataset. The number of datapoints that form a test dataset are randomly selected from the synthetic dataset. The synthetic datasets and test datasets have an arbitrary size such that different synthetic datasets and different test datasets may have a different number of datapoints. The datapoints from a synthetic dataset which do not form part of the corresponding test dataset are referred to as the holdouts. The PFN is trained to predict or generate the holdouts for each synthetic dataset from the corresponding test dataset.

For example, if a synthetic dataset comprises datapoints d⁽¹⁾=(x⁽¹⁾, y⁽¹⁾, d⁽²⁾=(x⁽²⁾, y⁽²⁾, d⁽³⁾=(x⁽³⁾, y⁽³⁾, d⁽⁴⁾=(x⁽⁴⁾, y⁽⁴⁾ and d⁽⁵⁾=(x⁽⁵⁾, y⁽⁵⁾, the test dataset D comprises only datapoints d⁽¹⁾=(x⁽¹⁾, y⁽¹⁾), d⁽²⁾=(x⁽²⁾, y⁽²⁾), and d⁽⁵⁾=(x⁽⁵⁾, y⁽⁵⁾), then the PFN is trained to (i) predict y⁽³⁾ from x⁽³⁾ and D; and (ii) predict y⁽⁴⁾ from x⁽⁴⁾ and D. Specifically, Muller et al. propose updating the parameters of the machine learning model via gradient descent to minimizing the log-likelihood.

The PFN learns properties to generalize over the plurality of synthetic datasets. In this manner the PFN is trained to learn the posterior predictive distribution (PPD) p(y|x, D). In some cases, there may be millions of synthetic datasets.

Mueller et al. indicate that many neural architectures can be used as the machine learning model. However, they explored architectures based on the Transformer encoder and a novel regression head for regression problems. Specifically, Mueller et al. describe an architecture based on a Transformer encoder without positional encodings, which makes it invariant to permutations in the dataset. The Transformer encodes each datapoint (e.g., each feature vector and a label combination) as a token, allowing token representations to attend to each other. For example, training samples/datapoints d⁽¹⁾=(x⁽¹⁾, y⁽¹⁾), d⁽²⁾=(x⁽²⁾, y⁽²⁾), d⁽³⁾=(x⁽³⁾, y⁽³⁾), are transformed into 3 tokens, which attend to each other and test samples x⁽⁴⁾, and x⁽⁵⁾ attend only to the training samples.

Once the PFN has been pre-trained, the PFN can receive a new test or reference dataset D and an input or query x and predict y (i.e., generate p(y|x, D)). This may be referred to as the prediction or online stage or phase. The test or reference dataset can change from one inference to another such that the PFN performs in-context learning. Thus, the weights of a pre-trained PFN do not need to be updated to be able to generate a prediction for a new dataset. In contrast, the PFN has this knowledge built in.

Mueller et al. demonstrated that PFNs can be used to perform tabular classification problems. However, their work was limited to 30 training samples, balanced binary classification and 60 features.

Hollman et al. in “TabPFN: A Transformer That Solves Tabular Classification Problems In a Second”, The Eleventh International Conference on Learning Representations, 2022, built on the PFN concept to develop TabPFN, a trained Transformer that can do supervised classification for small tabular datasets. Specifically, Hollman et al. designed a prior based on Bayesian Neural Networks and Structural Causal Models (SCMs) to model complex feature dependencies and potential causal mechanisms underlying tabular data and trained a PFN on samples from the prior. In particular, the prior has a large space of structural causal models with preference for simple structure. After training, the trained TabPFN model accepts training samples (xₜᵣₐᵢₙ, yₜᵣₐᵢₙ) and test features xₜₑₛₜ, and yields predictions yₜₑₛₜ for the entire test set in a single forward pass.

By extending the prior (vs PFN), TabPFN can handle imbalanced classes and multi-classification problems. Furthermore, while PFNs use an encoder layer that accepts fixed dimensional inputs, Tab PFN accepts datasets with different numbers of dimensions. Hollman et al. proposed a 12-layer Transformer, embeddings size 512, hidden size 1024 in feed forward layers and 4-head attention.

It has been shown that a TabPFN can generalize to virtually any tabular dataset (a dataset comprising columns and rows) through in-context learning.

Since PFNs and TabPFNs are configured to predict the label(s) y, PFNs and TabPFNs are suitable for classification and regression problems. Specifically, classification and regression are both supervised machine learning techniques that use labeled data (e.g. (x⁽ⁱ⁾, y⁽ⁱ⁾) pairs) to find patterns and predict outcomes. They differ in the type of output. Specifically, classification predicts categorical output, such as a label or class from a predefined list. In contrast, regression predicts continuous numerical output, such as a real-valued number that can vary within a range. However, it would be desirable to have a foundation model that can perform generative tasks (e.g., generate data) on/for tabular data.

Ma et al. in “TabPFGen=Tabular Data Generation with TabPFN”, NeurIPS 2023 Second Table Representation Workshop, 2023, devised a technique to turn TabPFN into an energy-based generative model, which is referred to as TabPFGen. TabPFGen leverages the strong in-context performance of TabPFN to devise a class-conditional generative model. In particular, TabPFGen generates p(x|y) using TabPFN. Specifically, given a trained TabPFN model f, TabPFGen obtains f(x_{synth}) using (xₜᵣₐᵢₙ, yₜᵣₐᵢₙ) as training data. Then the class conditioned energy E(x|y):=−f(x)[y] is computed using E(x_{synth}|y_{synth}):=−f(x_{synth})[y_{synth}]. The stochastic gradient Langevin dynamics (SGLD) method is then used to sample from this energy-based model to generate a batch of x_{synth}. TabPFN harnesses a pre-trained TabPFN to generate an energy-based model for tabular data generation without additional training.

Accordingly, TabPFN provides a way to sample from the in context-distribution p(d|D). In other words, it gives the distribution of a datapoint given a training dataset. However, it would be more beneficial to be able to generate the whole unconditional distribution p(D). Specifically, once a generative model has learned the full unconditional distribution p(D), then in principle the generative model can then generate from any conditional

$$p ( ( {d}_{{j}_{1}}^{( {i}_{1} )} , … , {d}_{{j}_{l}}^{( {i}_{l} )} ) \vert {D}_{test} ∖ ( {d}_{{j}_{1}}^{( {i}_{1} )} , … , {d}_{{j}_{l}}^{( {i}_{l} )} ) ) - i . e . ,$$

it can then impute any missing entries in a dataset given the rest of a dataset. Thus, any combination of individual entries or elements

$${d}_{j}^{( i )}$$

of a dataset can pe imputed.

While it is possible to argue that in principle learning p(d|D) is sufficient for imputing individual entries or elements

$${d}_{j}^{( i )}$$

of a datapoint, learning p(D) allows the model to generate entries that are correlated across datapoints. Imputations that are correlated across datapoints are highly desirable since it is desirable for imputations to be consistent across datapoints. Furthermore, as described in more detail below, learning p(D) is conceptually simpler and easier to implement in terms of time and computing resources that learning p(d|D).

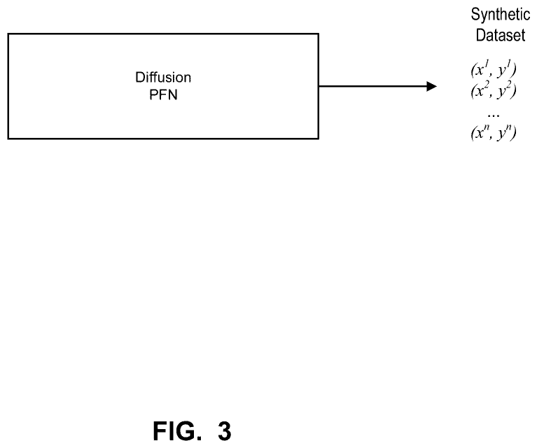

Accordingly described herein are methods and systems for generating a generative foundation model for tabular data. In the examples described herein the generative foundation model (which may be referred to as a diffusion PFN) is generated by training, using diffusion modelling and a plurality of different synthetic datasets from a prior, a large model (e.g., a transformer model) to generate an entire synthetic dataset. Each of a plurality of synthetic datasets may be generated, for example, in a similar manner to how the synthetic datasets are generated for PFN or TabPFN (e.g., by randomly sampling a prior). Accordingly, where PFNs and TabPFNs generate p(y|x, D), a diffusion PFN generates p(D) directly. Thus, as shown in FIG. 3, a diffusion PFN can generate an entire synthetic dataset (e.g., a set of datapoints (x,y)) from scratch whose distribution is consistent with the prior.

Once the machine learning model has been trained to generate an entire synthetic dataset, the trained machine learning model can be conditioned to perform a plurality of tasks including (i) generating a synthetic dataset from scratch, (ii) classification, (iii) regression, (iv) imputation, and/or (v) density estimation. Each of these will be described in more detail below. Thus, the proposed diffusion PFN is a more generalized version of a PFN or a TabPFN which can be used for more than just classification and regression tasks.

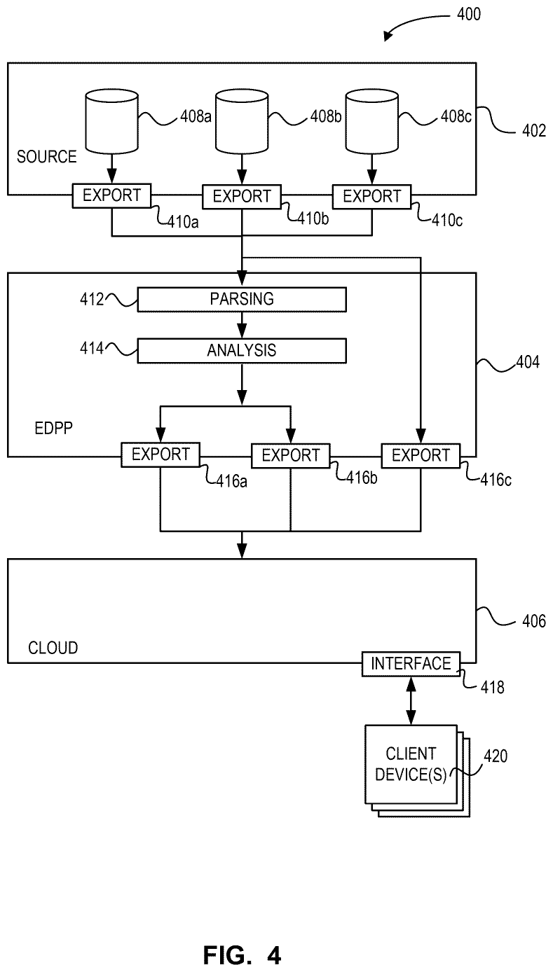

Reference is now made to FIG. 4, which illustrates a block diagram of an example computing system 400 for generating a diffusion PFN and using the diffusion PFN to generate data, and specifically tabular data. Computing system 400 comprises a source database system 402, an enterprise data provisioning platform (EDPP) 404 operatively coupled to the source database system 402, and a cloud-based computing cluster 406 that is operatively coupled to the EDPP 404.

Source database system 402 has one or more databases, of which three are shown for illustrative purposes: database 408a, database 408b and database 408c. One or more of the databases of the source database 402 may contain confidential information that is subject to restrictions on exports. One or more export modules 410a, 410b, 410c may periodically (e.g., daily, weekly, monthly, etc.) export data from the databases 408a, 408b, 408c to the EDPP 404. In some instances, the data is exported on an ad hoc basis.

EDPP 404 receives source data exported by the export modules 410a, 410b, 410c of source database system 402, processes it and exports the processed data to an application database within the cloud-based computing cluster 406. For example, a parsing module 412 of EDPP 404 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 414 or an export module 416a, 416b, 416c. In particular, parsed data can then be processed and transmitted to the cloud-based computing cluster 406 by a reporting and analysis module 414. Alternatively, one or more export modules 416a, 416b, 416c can export the parsed data to the cloud-based computing cluster 406.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data and thus may not be resourced or otherwise suitable for use in broader dissemination of the data. In some cases, to comply with such restrictions, one or more module of the EDPP 404 may “de-risk” data tables that contain confidential data prior to transmission to the cloud-based computing cluster 406. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 406 is configured to generate a diffusion PFN and process data received from the EDPP 404 using the diffusion PFN. The cloud-based computing cluster 406 includes an interface 418, which facilitates data communication with one or more client devices 420.

In some environments, the EDPP may be omitted. In such cases the cloud-based computing cluster 406 may receive the data, for processing by the diffusion PFN, directly from the source database system 402.

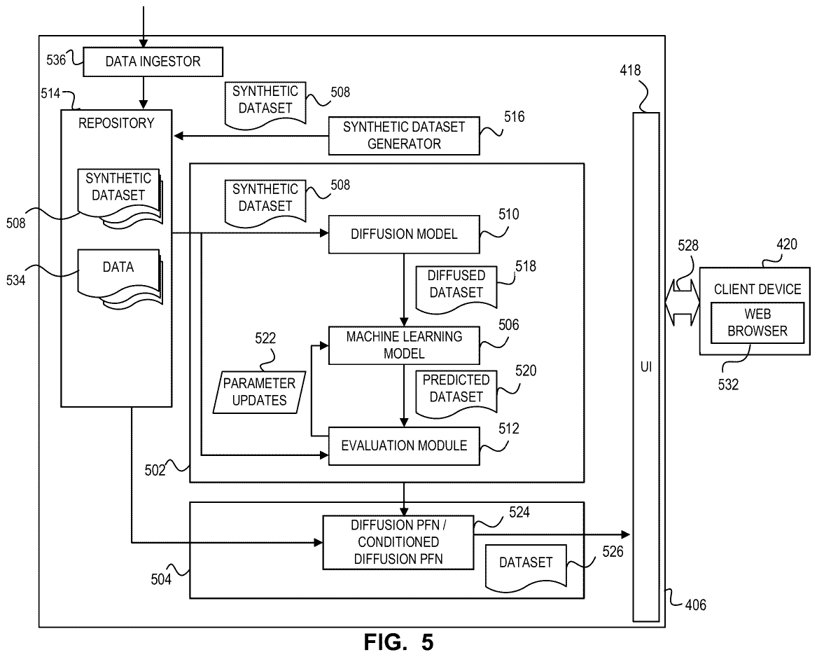

Reference is now made to FIG. 5, which illustrates an example implementation of the cloud-based computing cluster 406 of FIG. 4. As described above, the cloud-based computing cluster 406 is configured to generate a generative foundation model for tabular data, which is referred to herein as a diffusion PFN, and use the diffusion PFN to generate tabular data. In the example shown in FIG. 5 the cloud-based computing cluster 406 comprises a first system 502 which is configured to generate the diffusion PFN and a second system 504 which is configured to use the diffusion PFN to generate tabular data.

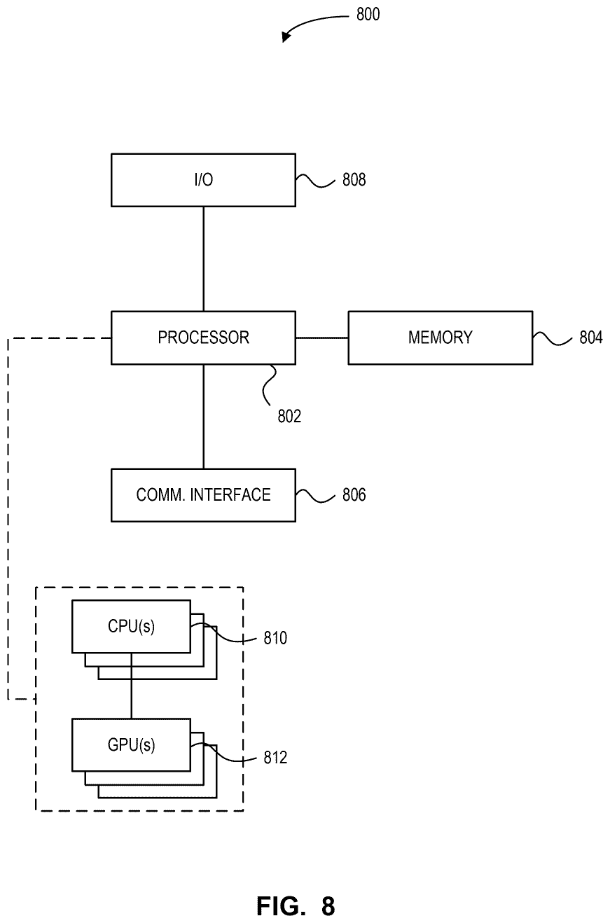

In some cases, one or more components of the cloud-based computing cluster 406 may be implemented by one or more computers within the cloud-based computing cluster, such as not limited to, computer 800 described below with respect to FIG. 8. In some cases, one or more components of the cloud-based computing cluster 406 may be implemented as virtual machines within the cloud-based computing cluster.

The first system 502 is configured to generate the diffusion PFN by training a machine learning model 506 to generate a plurality of synthetic tabular datasets 508 (i.e., to generate p(D)) using diffusion modelling. In the example shown in FIG. 5, the first system 502 comprises the machine learning model 506, a diffusion model 510 and an evaluation module 512.

The plurality of synthetic tabular datasets 508 are synthetic datasets D generated by sampling a prior. Each dataset, D, comprises an arbitrary number n of datapoints

$${d}^{( i )} = ( {x}^{( i )} , {y}^{( i )} ) = ( {d}_{1}^{( i )} , … , {d}_{k}^{( i )} ) where {d}_{k}^{( i )} = y and {y}^{( i )}$$

is the output for x⁽ⁱ⁾

$$( i . e . , D = \{ {d}^{( 1 )} , … , {d}^{( n )} \} = {\{ ( {x}^{( i )} , {y}^{( i )} ) \}}_{i = 1}^{n} ) .$$

### Each

$${d}_{j}^{( i )}$$

of a datapoint i is referred to as entry or an element of the datapoint. An entry that forms part of x⁽ⁱ⁾ is referred to as a feature, and an entry that forms part of y⁽ⁱ⁾ is referred to as a target or a label. n and k can vary between datasets such that the number of datapoints per dataset and the number of entries per datapoint may vary between datasets.

In some cases, the plurality of synthetic tabular datasets 508 are generated from a prior that represents tabular datasets in the real world. In some cases, the prior is based on Structural Causal Models (SCMs) and/or Bayesian Neural Networks to model complex feature dependencies and potential causal mechanisms underlying tabular data as described by Hollman et al.

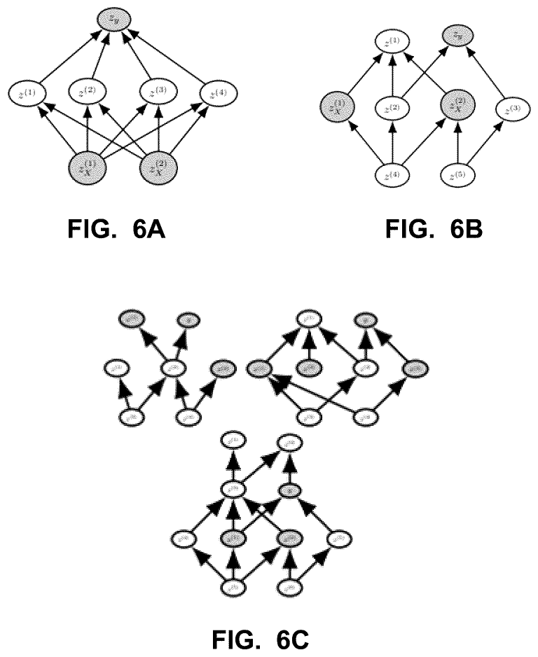

Specifically, since tabular data often exhibits causal relationships between columns, in some cases, the prior for the diffusion PFN may be based on SCMs that model causal relationships. An SCM is a collection Z:=({z₁, . . . , zₖ}) of structural assignments (called mechanisms): zᵢ=ƒᵢ(z_{PA}_{_{G(i)}}, ϵᵢ), where PA_{G(i)} is the set of parents of the node i (its direct causes) in an underlying DAG G (the causal graph), ƒᵢ is a (potentially nonlinear) deterministic function and ϵᵢ is a noise variable. Causal relationships in G are represented by directed edges pointing from causes to effects and each mechanism z; is assigned to a node in G. An example SCM is shown in FIG. 6B.

To create a prior based on SCMs a plurality of datasets may be generated wherein each dataset is based on one randomly-sampled SCM (including the DAG structure and deterministic functions ƒᵢ). Given an SCM, a set of nodes z_{X} in the causal graph G are sampled (one for each feature) along with one node z_{y} from G. For each SCM and set of nodes (z_{X}, z_{y}) a plurality(e.g., n) samples are generated by sampling all noise variables in the SCM n times. These are then propagated through the graph and the values for all the identified nodes (zₓ, z_{y}) are retrieved for all n samples. FIG. 6C shows example SCMs sampled from the prior.

In some cases, the prior may also, or alternatively, be based on Bayesian Neural Networks (BNNs). A BNN is a type of neural network that incorporates uncertainty into its predictions. Specifically, when a regular neural network makes a prediction, it gives a simple value based on the inputs. However, BNNs not only make a prediction but qualify the uncertainly. This is achieved by treating the weights of the BNN as distributions instead of fixed numbers. In some cases, datasets for the prior may be generated by (1) sampling a BNN architecture; (2) sampling model weights for the selected architecture; (3) for each datapoint, an input is sampled for each feature; (4) for each datapoint, the selected features are fed through the BNN with sampled noise variables and the output y is used as the target for that set of features. An example BNN is shown in FIG. 6A.

In some cases, the datasets may be sampled from either one or the other prior (SCN prior or BNN prior) with equal probability.

Where the SCN or the BNN returns a scalar label, in order to generate synthetic classification labels for imbalanced multi-class datasets, the scalar labels may be transformed into discrete class labels. In some cases, this may be implemented by splitting the values of the scalar labels into intervals that map to class labels by: (1) sampling the number of classes N_{c}~p(N_{c}); (2) sampling N_{c}−1 class bounds Bᵢ randomly from the set of continuous targets y; and (3) mapping each scalar label y to the index of the unique interval that contains it.

Generating synthetic datasets from a combination of SCMs and BNNs has proven a powerful inductive basis for applying large models, such as machine learning models with a transformer backbone, to small datasets.

In some cases, the synthetic tabular datasets 508 may be stored in a repository 514 of the cloud-based computing cluster 406. The repository 514 may be any mechanism or device, such as memory, that can store digital information. In some cases, the cloud-based computing cluster 406 may receive the plurality of synthetic tabular datasets 508 from, for example, the source database system 402 or the EDPP 404. However, in other cases, the cloud-based computing cluster 406 may comprise a synthetic dataset generator 516 which is configured to generate the plurality of synthetic tabular datasets 508 in accordance with any of the methods described above.

The machine learning model 506 is a large and/or powerful machine learning model, such as, but not limited to, a deep learning model with a transformer architecture. In some cases, the machine learning model 506 is a deep learning model with a transformer architecture, however, instead of having one token per datapoint

$$( i . e . , per {d}^{( i )} = ( {x}^{( i )} , {y}^{( i )} ) = ( {d}_{1}^{( i )} , … , {d}_{y}^{( i )} ) )$$

like TabPFN, there is a token for each

$${d}_{j}^{( i )}$$

in a dataset—i.e., for each entry in the dataset. This allows any entry

$$( {d}_{j}^{( i )} )$$

in a dataset D to be imputed by its outputs. An example tokenizer which may be used to implement this is described in Zhang et al., “Mixed-Type Tabular Data Synthesis With Score-Based Diffusion in Latent Space”, arXiv preprint arXiv:2310.0956, 2023. Specifically, in the example tokenizer the dataset D is represented as a matrix

$${( {d}_{j}^{( i )} )}_{i , j}$$

and each column is converted into an n-dimensional vector. First one-hot encoding is used to process categorical features. Each datapoint is represented as a vector. Then, a linear transformation is applied for numerical columns which creates an embedding lookup table for columns, where each category is assigned a learnable n-dimensional vector. Now, each dataset is expressed as the stack of the embeddings of all columns. Having a token for each entry in a dataset, versus having a token for each datapoint, makes the context much larger.

Regarding positional encoding, where the dataset is represented by a matrix, the machine learning model 506 uses both column and row indices. However, it is desirable that the order of the columns and rows does not matter. Accordingly, in some cases, this may be addressed by using a random noise vector for each row zᵣ~N(0,I) and a random noise vector for each column z_{c}~N(0,I). In some cases, either or both of these random noise vectors may be added to the encoding of an entry in the dataset

$$( e . g . , {( {d}_{j}^{( i )} )}_{i , j} ) .$$

The diffusion model 510 and the evaluation module 512 are used to train the machine learning model 506 to generate entire datasets p(D) using diffusion modelling. Fundamentally, diffusion modelling works by corrupting training data and then teaching a model to recover the original data by reversing this corruption process. Specifically, the model is trained to iteratively undo a forward corruption process q that corrupts clean data c and defines latent variables zₜ for t∈[0,1] that represent progressively noisy versions of c. After training, the trained machine learning model can be used to generate data that mimics the training data by simply passing random sampled noise to the trained model. Training a model using diffusion modelling has shown to be an effective method to train a model to generate continuous data but it also has been shown to handle the generation of discrete data.

The process of corrupting an input is called forward diffusion. In the example of FIG. 5, the forward diffusion is performed by the diffusion model 510. Specifically, the diffusion model 510 is configured to receive a synthetic tabular dataset 508 and corrupt the received synthetic dataset to generate a corrupted or diffused dataset 518. The diffusion model 510 may gradually corrupt the received synthetic dataset over a series of steps. In some cases, the diffusion model 510 may be a patent variable model which maps to the latent space using a Markov chain. Specifically, this chain may gradually add Gaussian noise to the received synthetic dataset over a number of steps. In these cases, each step of the forward diffusion process may be defined by equation (1) where ε=N(0,I) and (αₜ)_{t∈[0,1]} is a noise schedule, monotonically decreasing in t. This has been shown to work well for continuous data.

$${z}_{t} = \sqrt{{α}_{t}} c + \sqrt{1 - {α}_{t}} ε \qquad ( 1 )$$

In other cases, the diffusion model 510 may implement masked or absorbing state diffusion. In masked diffusion or absorbing state diffusion, during the forward diffusion step the data is gradually transformed or “absorbed” into a specific state. This state could be a form of noise or even an absorbing state (a state that once reached, doesn't evolve further). This is done using a mask. Specifically, each step a subset of the entries in the input are masked out. This gradually destroys the information in the input. If enough steps are performed, you end up with a fully masked output. This has been shown to work well for discrete data. Any suitable masked or absorbing diffusion method may be used.

One example method of masked diffusion which may be implemented by the diffusion model 510 is described in Sahoo et al., “Simple and Effective Masked Diffusion Language Models”, arXiv e-prints, pages arXiv-2406, 2024. In this example, scalar discrete random variables with K categories are denoted as “one-hot” column vectors an V E

$$V ∈ \{ c ∈ {\{ 0 , 1 \}}^{K} : {\sum }_{i = 1}^{K} {c}_{i} = 1 \}$$

is defined as the set of all vectors. Cat(.;π) is defined at the
categorical distribution over K classes with probabilities given by w∈Δ^{K}, where Δ^{K} denotes the K-simplex. They start with a forward process that interpolates between clean data c and a target distribution Cat(.;π) forming a direct extension of the Gaussian diffusion described above. If q defines a sequence of increasingly noisy latent variables zₜ where the time step t runs from t=0 (least noisy) to t=1 (most noise), then the marginal of zₜ conditional on c at time t is shown in equation (2) where αₜ∈[0,1] is a strictly decreasing function in t, with α₀≈1 and α₁≈0.

$$q ( {z}_{t} \vert c ) = Cat ( {z}_{t} ; {α}_{t} c + ( 1 - {α}_{t} ) π ) \qquad ( 2 )$$

This implies transition probabilities q(zₜ|zₛ)=Cat(zₜ; α_{t|s}zₛ+(1−α_{t|s})π) where α_{t|s}=αₜ/αₛ. This indicates that during each diffusion step from s→t, a fraction of the probability mass is transferred to the prior distribution if. The reverse posterior is given in equation (3).

$$q ( {z}_{s} \vert {z}_{t} , c ) = Cat ( {z}_{s} ; \frac{[ {α}_{t \vert s} {z}_{t} + ( 1 - {α}_{t \vert s} ) 1 {π}^{T} {z}_{t} ] ⊙ [ {α}_{s} c + ( 1 - {a}_{s} ) π ]}{{α}_{t} {z}_{t}^{T} c + ( 1 - {α}_{t} ) {z}_{t}^{T} π} ) \qquad ( 3 )$$

In masked diffusion if is set to m. At each noising step t, the input c transitions to a ‘masked’ state m with some probability. If an input transitions to m at any time t′, it will remain in this state for all t >t′: q(zₜ|zₜ, =m)=Cat(zₜ; m). At time T, all inputs are masked with probability I. The marginal of the forward process is given by equation (4).

$$q ( {z}_{t} \vert c ) = Cat ( {z}_{t} ; {α}_{t} c + ( 1 - {α}_{t} ) π ) \qquad ( 4 )$$

From properties of the masking process the posterior q(zₛ|zₜ, c) simplifies to equation (5).

$$q ( {z}_{s} \vert {z}_{t} , c ) = \{ \begin{matrix}Cat ( {z}_{s} ; {z}_{t} ) , & {z}_{t} \neq m \\ Cat ( {z}_{s} ; \frac{( 1 - {α}_{s} ) m + ( {α}_{s} - {α}_{t} )}{1 - {α}_{t}} , & {z}_{t} = m\end{matrix} \qquad ( 5 )$$

During training, synthetic datasets of the plurality of synthetic datasets are provided to the diffusion model 510 which performs a diffusion process thereon to generate corresponding diffused datasets 518.

The machine learning model 506 is then trained to perform the reverse diffusion process on the diffused datasets 518. Specifically, during training, each of the diffused datasets 518 output by the diffusion model 510 is provided to the machine learning model 506 where the machine learning model 506 generates an output therefore (e.g., a predicted dataset 520). The goal is to have the machine learning model 506 generate, in response to processing a diffused dataset 518, the corresponding synthetic tabular dataset 508. This is accomplished by the evaluation module 512 comparing the output of the machine learning model 506 in response to a diffused synthetic dataset (i.e., the predicted dataset 520) to the corresponding synthetic tabular dataset 508, generating a loss function therefrom and adjusting the parameters 522 of the machine learning model 506 to minimize the loss function. The loss function that is minimized may be any suitable loss function and may be based on the diffusion process used by the diffusion model 510 to corrupt the synthetic datasets. In some cases, training involves minimizing the variational upper/lower bound on the negative log likelihood.

For example, where the diffusion model 510 implements the process represented by equations (2) and (3), the parameters of the machine learning model 506 (wherein the machine learning model is denoted p_{θ}) may be adjusted so as to maximize a variational lower bound on log-likelihood (ELBO). Specifically, given a number of discretization steps T, defining s(i)=(i−1)/T and t(i)=i/T and using D_{KL}[⋅] to denote the Kullback-Leibler divergence, the Negative ELBO can be expressed by equation (6) where

$${\sum }_{i = 1}^{T} {D}_{K L} [ q ( {z}_{s ( i )} \vert {z}_{t ( i )} , c \vert \vert {p}_{θ} ( {z}_{s ( i )} \vert {z}_{t ( i )} ) ]$$

is the diffusion-related loss ( [symbol] _{diffusion}).

$${E}_{q} [ - log {p}_{θ} ( c \vert {z}_{t ( 0 )} ) ] + {\sum }_{i = 1}^{T} {D}_{K L} [ q ( {z}_{s ( i )} \vert {Z}_{t ( i )} , c \vert \vert {p}_{θ} ( {z}_{s ( i )} \vert {z}_{t ( i )} ) ] + {D}_{K L} [ q ( {z}_{t ( T )} \vert c \vert \vert {p}_{θ} ( {z}_{t ( T )} ) ] \qquad ( 6 )$$

In another example, where the diffusion model 510 implements the diffusion process represented by equations (4) and (5), as per Sahoo, the parameters of the machine learning model 506 may be adjusted to so as to maximize the variational lower bound on log-likelihood (ELBO) which is simplified, with respect to equation (6), to equation (7) where

$${\sum }_{i = 1}^{T} [ \frac{{α}_{t ( i )} - {α}_{s ( i )}}{1 - {α}_{t ( i )}} log 〈 {c}_{θ} ( {z}_{t ( i )} ) , c 〉 ]$$

is the diffusion-related loss ( [symbol] _{diffusion}).

$${E}_{q} [ - log {p}_{θ} ( c \vert {z}_{t ( 0 )} ) ] + {\sum }_{i = 1}^{T} [ \frac{{α}_{t ( i )} - {α}_{s ( i )}}{1 - {α}_{t ( i )}} log ( {c}_{θ} ( {z}_{t ( i )} ) , c 〉 ] + {D}_{K L} [ q ( {z}_{t ( T )} \vert c \vert \vert {p}_{θ} ( {z}_{t ( T )} ) ] \qquad ( 7 )$$

Once the machine learning model has been trained to generate the synthetic datasets (i.e., it has learned how to reverse the diffusion process), then the resulting trained machine learning model, which may be referred to as a diffusion PFN 524, is added to the second system 504, can be used to generate a synthetic dataset 526 from scratch. Specifically, the trained machine learning model (i.e., diffusion PFN 524) may be provided with a diffused dataset (e.g., a random dataset) of the desired shape and size. The trained machine learning model (i.e., diffusion PFN 524) then removes the noise in the diffused dataset step by step to create a new dataset of the desired shape and size. Since the diffusion PFN 524 has learned to reverse the process from synthetic datasets from a prior, the new dataset it generates has a distribution that is consistent with the prior it was trained on.

In some cases, the generated dataset 526 is provided to a client device 420 that is connected over a data communication link 528 to the user interface 418 of the cloud-based computing device. For example, the generated dataset 526 may be provided to the user via a web browser 532 or some other application that operates on the client device 420.

In some cases, once the machine learning model has been trained to generate datasets in accordance with the prior (i.e., to generate p(D)) (e.g., the diffusion PFN 524 has been generated), the trained machine learning model (i.e., the diffusion PFN 524) may be modified or conditioned so that it can be used to perform a more diverse set of tasks, such as, but not limited to imputation. The original machine learned model is referred to as unconditioned or an unconditional model and the modified model may be referred to as a conditioned or conditional model. An unconditional diffusion-trained model models a data distribution p(A) whereas a conditional diffusion model models a conditional distribution p(A|B), where the output of the model is guided by additional information B. In other words, a conditional or conditioned diffusion-trained model takes additional inputs as conditions to control the generation process.

In the image context, in-painting is something that is commonly performed with a machine learning model that has been trained using diffusion modelling to generate images. In-painting is the process of inferring missing parts in an image based on available regions specified by a binary mask (which may be referred to as a segmentation mask). Specifically, a standard machine learning model that has been trained using diffusion modelling to generate images may be able to generate all of the pixels of an image together in response to receiving a set of random inputs that match the desired shape and size of the image. However, such a trained model can also be modified to condition on available image regions to produce high quality inferences (e.g., missing image regions). Specifically, a modified model can be generated that leverages the trained model's ability to generate images while conditioning on the observed part(s) of an image so that the modified model generates missing parts of the image based on the observed part(s) of the image.

This may be implemented by generating a mask (e.g., a binary mask) which indicates which pixels of the image are to be generated (e.g., the pixels that are missing) and generating a modified model to perform conditioned processing—i.e., use the provided context (the pixels of the image that are not to be generated or modified) to generate the identified pixels using the reverse diffusion process.

The model may be modified to implement conditional processing in a number of different ways. In some cases, this may be implemented via a conditional denoising autoencoder ϵ_{θ}(zₜ,t,r) which allows the synthesis (i.e., image generation) process to be controlled through inputs r, such as, but not limited to, the map and the input image. See, for example, Rombach et al., “High-Resolution Image Synthesis with Latent Diffusion Models” in Proceedings of the IEE/CVF Conference on Computer Vision and Pattern Recognition, pages 10684-10695, 2022, for a description of conditioning a diffusion model for inpainting.

Inpainting can be seen as one example or form of imputation (i.e., estimating or inferring missing values in a dataset using algorithms and other datapoints). Thus, methods similar to those used to condition a model trained to generate an image to perform inpainting can be used to condition the trained machine learning model (e.g., diffusion PFN 524) to perform imputation—i.e., generate missing data from a dataset. Specifically, the trained machine learning model may be conditioned down, for example, to receive a partial dataset and a mask indicating which datapoints or elements of a dataset are to be generated based on the partial dataset. Once the trained machine learning model (e.g., diffusion PFN 524) has been conditioned to generate missing data from a dataset it can be used to perform a variety of tasks.

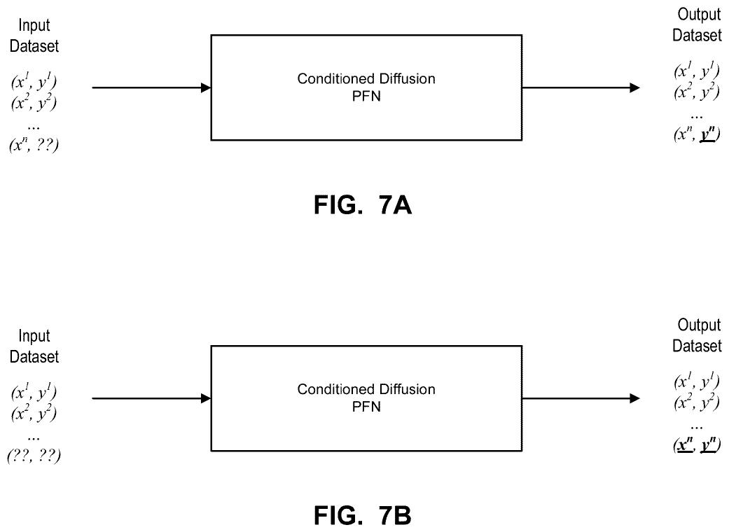

For example, as shown in FIG. 7A, a conditioned diffusion PFN may be used to perform in-context classification or regression by providing the conditioned diffusion PFN with an incomplete dataset—e.g., a dataset that comprises a plurality of example datapoints (x¹, y¹; x², y², . . . xⁿ⁻¹, yⁿ⁻¹) and a partial datapoint, with only, for example, a set of features (e.g., xⁿ), but without the corresponding target (e.g., yⁿ)—and causing the conditioned diffusion PFN to generate the missing target (e.g., yⁿ). In this way the diffusion PFN acts like a PFN (or TabPFN) described above in that it can generate a prediction yⁿ, based on a test dataset (x¹, y¹; x², y², . . . xⁿ⁻¹, yⁿ⁻¹) and an input xⁿ. Thus, it can perform in-context learning.

In another example, as shown in FIG. 7B, a conditioned diffusion PFN may be used to perform in-context generation of datapoints by providing the conditioned diffusion PFN with an incomplete dataset—e.g., a dataset that comprises a plurality of datapoints (x¹, y¹; x², y², . . . xⁿ⁻¹, yⁿ⁻¹) and causing the conditioned diffusion PFN to generate an additional datapoint (e.g., xⁿ, yⁿ) that is consistent with the provided datapoints.

In another example, where a mask is used to identify the elements of a dataset that the conditioned diffusion PFN is to generate, then the conditioned diffusion PFN may be used to generate an entire dataset by providing the conditioned diffusion PFN with a dataset of the desired shape and size with random or noise datapoints, and generating a mask that indicates that all of the datapoints of the dataset are to be generated.

Furthermore, since a diffusion PFN learns the distribution p(D), when it is used to perform classification or regression, for example, the conditioned diffusion PFN can not only output a final prediction (a number), but it can predict a distribution over those numbers. So, it can perform uncertainty quantification. This is the difference between saying the result is 800 vs saying with 90% confidence the result is between 790 and 810. Accordingly, by learning the entire distribution p(D), a diffusion PFN can generate density estimates to get uncertainty estimates.

Accordingly, a conditioned diffusion PFN can be used to perform all of the tasks that a PFN or TabPFN can perform (e.g., classification and regression), but it can also be used to perform a number of other tasks such as, but not limited to, generation of datapoints consistent with a dataset and complete dataset generation, making it a much more valuable and flexible model.

Where the trained machine learning model (diffusion PFN) has been modified to perform conditional processing then, in FIG. 5, it may be the conditioned diffusion PFN that is used to generate the dataset 526. In such cases, the conditioned diffusion PFN may be provided with an input tabular dataset and information (e.g., a mask) indicating which elements of the input tabular dataset are to be generated and the conditioned diffusion PFN may be configured to generate the identified elements of the input dataset based on the other elements of the input tabular dataset. In such cases, the data 534 used to generate the input tabular dataset may be received from the source database system 402 or the EDPP 404 via, for example, a data ingestor 536 and stored in the repository 514.

### Example Computer

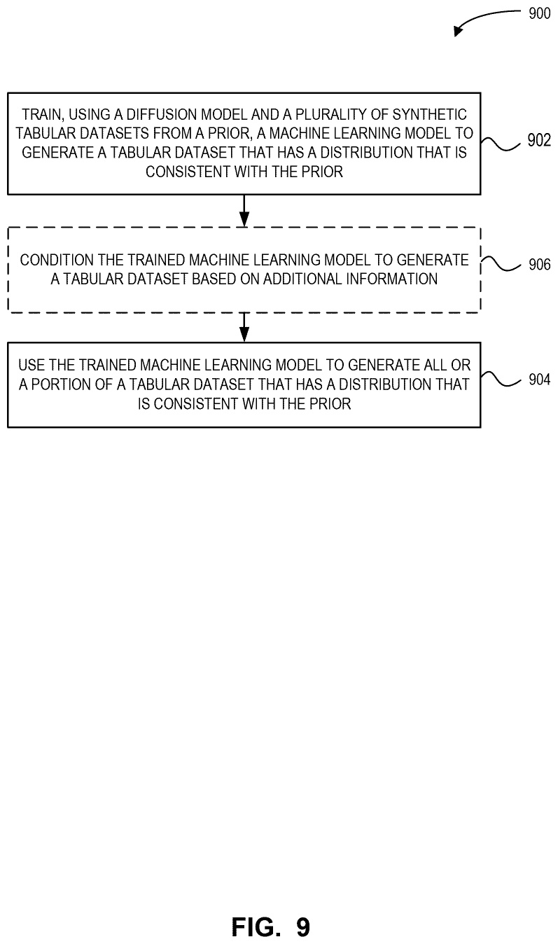

Reference is now made to FIG. 8 which illustrates a simplified block diagram of an example computer 800. Computer 800 is an example implementation of a computer which may implement the source database system 402, EDPP 404, one or more components of the cloud-based computing cluster 406 of FIGS. 4 and 5 and/or the method 900 of FIG. 9. Computer 800 has at least one processor 802 operatively coupled to at least one memory 804, at least one communications interface 806 (also referred to herein as a network interface), and at least one input/output (I/O) device 808.

The at least one memory 804 includes a volatile memory that stores instructions executed or executable by the processor 802, and input and output data used or generated during execution of the instructions. The memory 804 may also include non-volatile memory used to store input and/or output data—e.g., within a database—along with program code containing executable instructions.

The processor 802 may transmit or receive data via the communications interface 806 and may also transmit or receive data via any additional input/output device 808 as appropriate.

In some cases, the processor 802 includes a system of central processing units (CPUs) 810. In other cases, the processor 802 includes a system of one or more CPUs 810 and one or more Graphical Processing Units (GPUs) 812 that are coupled together. For example, any combination of the machine learning models 506 and diffusion PFNs 524 described herein may execute neural network computations on CPU and GPU hardware, such as the system of CPUs 810 and GPUs 812 of FIG. 8.

### Method

Reference is now made to FIG. 9 which illustrates an example method 900 of automatically generating tabular data that has a distribution that is consistent with a prior. The method 900 begins at block 902 where a machine learning model (e.g., a machine learning model with a transformer architecture) is trained, using a diffusion model and a plurality of synthetic tabular datasets representing a prior, to generate a tabular dataset that has a distribution that is consistent with the prior. In other words, the machine learning model is trained to generate p(D). As described above, in some cases the prior may be based on Bayesian Neural Networks (BNNs) and/or Structural Causal Models (SCMs) to model complex feature dependencies and potential causal mechanisms underlying tabular data and the plurality of synthetic tabular datasets may be generated by sampling one or more BNNs and/or one or more SCMs.

As described above, training the machine learning model using a diffusion model and the plurality of synthetic tabular datasets may comprises diffusing each of the plurality of synthetic tabular datasets, passing each of the plurality of diffused datasets through the machine learning model to generate a predicted dataset, and adjusting the parameters of the machine learning model based on a comparison of each of the predicted datasets and the corresponding synthetic tabular dataset so that the machine learning model performs the reverse of the diffusion process. In some cases, the adjusting of the parameters of the machine learning model may be iterative. For example, in some cases (1) diffused datasets may be generated for a set of synthetic tabular datasets, (2) the set of synthetic tabular datasets may be processed by the machine learning model to generate corresponding predicted datasets, and (3) the parameters of the machine learning model may be adjusted or updated based on a comparison of the predicted datasets and their corresponding synthetic tabular datasets. Steps (1), (2) and (3) may then be repeated for a set of synthetic tabular datasets (which may be the same set or a different set from the one used in the previous iteration) and so on. This may be repeated until an error or loss metric based on a comparison of the predicted datasets and their corresponding synthetic tabular datasets reaches a certain level. Once the machine learning model has been trained, the method 900 proceeds to block 904.

At block 904, the trained machine learning model is used to generate all or a portion of a tabular dataset with a distribution that is consistent with the prior. In the simplest case this may comprise providing the trained machine learning model with an input dataset of the desired shape and size that is just noise, and in response to receiving the input dataset the trained machine learning model generates a tabular dataset of the desired shape and size that has a distribution that is consistent with the prior.

However, in some cases, the method 900 may comprise an additional block, block 906 which precedes block 904, in which the trained machine learning model is conditioned to perform the generation of all or a portion of a dataset based on additional information. In some cases, the additional information comprises (i) an input tabular dataset comprising one or more datapoints, each datapoint comprising one or more elements, and (ii) information (e.g., a mask) identifying one or more elements of the input tabular dataset that are to be generated, and the conditioned trained machine learning model is configured to generate the identified one or more elements of the input tabular dataset based on the other elements of the input tabular dataset. The identified one or more elements of the input tabular dataset that are to be generated may be any combination of the elements of the input tabular dataset. For example, the identified elements may comprise all the elements of one or more datapoints of the input tabular dataset, or the identified elements may comprise only a subset of the elements of one or more datapoints of the input tabular dataset.

As described above, once the trained model has been conditioned in this way to generate identified elements of an input tabular dataset based on the other elements of the input tabular dataset it can be used to perform a number of tasks in context on a new, unseen dataset, including, but not limited to, classification, regression, data generation, data imputation, density estimation and qualifying model uncertainly and/or detecting anomalous inputs.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for generating tabular data, the system comprising:
a memory, a communication interface, and at least one processor operatively coupled to the memory and the communication interface;
the at least one processor configured to:
train, using a diffusion model and a plurality of synthetic tabular datasets representing a prior, a machine learning model to generate a tabular dataset that has a distribution that is consistent with the prior; and
use the trained machine learning model to generate all or a portion of a tabular dataset that has a distribution that is consistent with the prior.

2. The system of claim 1, wherein the at least one processor is further configured to, prior to using the trained machine learning model to generate all or a portion of the tabular dataset with a distribution that is consistent with the prior, condition the trained machine learning model to generate the tabular dataset in accordance with additional information.

3. The system of claim 2, wherein the additional information comprises (i) an input tabular dataset comprising one or more datapoints, each datapoint comprising one or more elements, and (ii) information identifying one or more elements of the input tabular dataset that are to be generated, and the conditioned trained machine learning model is configured to generate the identified one or more elements of the input tabular dataset based on other elements of the input tabular dataset.

4. The system of claim 3, wherein using the trained machine learning model to generate all or a portion of the tabular dataset that has a distribution that is consistent with the prior comprises using the conditioned trained machine learning model to perform one of classification, regression, data generation and data imputation.

5. The system of claim 3, wherein the identified one or more elements comprise each of the one or more elements of one or more datapoints of the input tabular dataset.

6. The system of claim 3, wherein the identified one or more elements comprise only a subset of the one or more elements of a datapoint of the input tabular dataset.

7. The system of claim 3, wherein the information identifying the one or more elements of the input tabular dataset that are to be generated comprises a mask.

8. The system of claim 1, wherein the machine learning model comprises a transformer architecture.

9. The system of claim 8, wherein a synthetic tabular dataset of the plurality of synthetic tabular datasets comprises one or more datapoints, and each datapoint of the one or more datapoints comprises one or more elements, and wherein the machine learning model is configured to tokenize each element of the synthetic tabular dataset.

10. The system of claim 1, wherein one or more synthetic tabular datasets of the plurality of synthetic tabular datasets was generated by sampling a Bayesian neural network.

11. The system of claim 1, wherein one or more of the synthetic tabular datasets of the plurality of synthetic tabular datasets was generated by sampling a structural causal model.

12. The system of claim 1, wherein the at least one processor is configured to train the machine learning model using the diffusion model and the plurality of synthetic tabular datasets by diffusing each of the plurality of synthetic tabular datasets in accordance with a diffusion process to generate a plurality of diffused datasets and adjusting parameters of the machine learning model to reverse the diffusion process on the plurality of diffused datasets.

13. The system of claim 12, wherein adjusting the parameters of the machine learning model to reverse the diffusion process comprises adjusting the parameters of the machine learning model so that the machine learning model generates, in response to receiving a diffused dataset, the corresponding synthetic tabular dataset.

14. A method for generating tabular data, the method executed in a computing environment comprising at least one processor, a communication interface, and memory, and the method comprising:
training, using a diffusion model and a plurality of synthetic tabular datasets representing a prior, a machine learning model to generate a tabular dataset that has a distribution that is consistent with the prior; and
using the trained machine learning model to generate all or a portion of a tabular dataset that conforms to the prior.

15. The method of claim 14, further comprising, prior to using the trained machine learning model to generate all or a portion of the tabular dataset with a distribution that is consistent with the prior, conditioning the trained machine learning model to generate the tabular dataset in accordance with additional information.

16. The method of claim 15, wherein the additional information comprises (i) an input tabular dataset comprising one or more datapoints, each datapoint comprising one or more elements, and (ii) information identifying one or more elements of the input tabular dataset that are to be generated, and the conditioned trained machine learning model is configured to generate the identified one or more elements of the input tabular dataset based on other elements of the input tabular dataset.

17. The method of claim 16, wherein using the trained machine learning model to generate all or a portion of the tabular dataset that has a distribution that is consistent with the prior comprising using the trained machine learning model to perform one of classification, regression, data generation and data imputation.

18. The method of claim 14, wherein the machine learning model comprises a transformer architecture.

19. The method of claim 18, wherein a synthetic tabular dataset of the plurality of synthetic tabular datasets comprises one or more datapoints, and each datapoint of the one or more datapoints comprises one or more elements, and wherein the machine learning model is configured to tokenize each element of the synthetic tabular dataset.

20. A non-transitory computer readable medium storing computer executable instructions which, when executed by at least one computer processor, cause the at least one computer processor to carry out a method for generating tabular data, the method comprising:
training, using a diffusion model and a plurality of synthetic tabular datasets representing a prior, a machine learning model to generate a tabular dataset that has a distribution that is consistent with the prior; and
using the trained machine learning model to generate all or a portion of a tabular dataset that has a distribution that is consistent with the prior.
